(19) United States
(12) Patent Application Publication
(10) Pub. No.: US 2022/0322690 A1
(43) Pub. Date: Oct. 13, 2022

(54) EDIBLE OIL-IN-WATER EMULSION COMPOSITION COMPRISING PLANT-BASED PROTEINS

(71) Applicant: Upfield Europe B.V., Rotterdan (NL)

(72) Inventors: Andries MORET, Rotterdam (NL); Georg Christian DOL, Rotterdam (NL); Comelis Antonius Maria ZUIJDERVLIET, Rotterdam (NL)

(21) Appl. No.: 17/642,540

(22) PCT Filed: Sep. 11, 2020
(86) PCT No.: PCT/EP2020/075461

§ 371 Date: Mar. 11, 2022

(30) Foreign Application Priority Data
Sep. 13, 2019 (EP) 19197221.5

(51) Int. Cl. A23D 7/005; A23D 7/00; A23D 7/02; A23L 9/20; A23C 11/10

(52) U.S. Cl. CPC A23D 7/0053; A23D 7/003; A23D 7/02; A23L 9/24; A23C 11/103; A23C 2210/30; A23V 2002/00

(57) ABSTRACT

The invention relates to an edible oil-in-water emulsion comprising an fat phase, a water phase and a plant-based protein comprising an fat phase a water phase, and wherein the emulsion further comprises 0.01-10 wt. % of a plant-based-protein, the use of the emulsion a non-dairy containing a multipurpose cooking cream and or whipping cream.

### FIELD OF THE INVENTION

The present invention relates to an edible oil-in-water emulsion composition, a method for the preparation of the edible oil-in-water emulsion composition, and use of the edible oil-in-water composition.

### BACKGROUND TO THE INVENTION

The abbreviations DCA for Dairy Cream Alternative is used throughout this description. Dairy cream is a natural foodstuff which is much appreciated by both consumers and professionals for its diverse applications. Traditionally, dairy creams can be suitable for whipping, for cooking or can be used for whipping and cooking (multipurpose cream). In whipped form, it is for instance used as a topping on or filling in cakes, pastries, puddings, desserts, as a topping on beverages such as coffee and hot chocolate drinks, or on ice creams, or folded into mousses, purees, etcetera. It may be used as an additive (without whipping) in many different sweet or savoury food products, such as beverages, soups, sauces, ice creams, puddings, confectionary, pralines, etcetera. In most of its applications, the dairy cream is valued for its contribution to the richness in taste, texture, and mouthfeel of the food it is consumed with or incorporated in.

Dairy cream has several drawbacks: It is relatively expensive and can have a more limited shelf-life (and shows fluctuations in its composition and hence in its properties. These fluctuations may lead to unexpected defects such as collapse of the whipped cream or phase separation (e.g. buttering or coagulation). These drawbacks have led to the development of substitute creams, so-called dairy cream alternatives (DCAs) that aim to be more cost-effective, or more consistent in their composition and hence more predictable in their applicability.

Typical conventional DCAs are oil-in-water emulsions based on vegetable or dairy fats and/or oils, a source of protein (e.g. milk powder) and emulsifiers. A wide variety of emulsifiers have been used in DCA formulations. For instance, EP 0 294 119 A1, EP 0 436 994 B1, EP 0 455 288 A1 and WO 94/17672 A1 describe whippable DCAs comprising e.g. caseinates, lecithins, mono-/diglycerides of fatty acids, or polyoxyethylene sorbitan monostearates as emulsifiers. Edible oil-in-water emulsions are known, for instance from WO2012/130611 where non-dairy cream emulsions or DCAs (dairy cream alternatives) are described that can be used in whipping applications or as an additive and that contain sucrose fatty acid esters in addition to other non-cream milk-based ingredients such as skim milk powder.

Over the years, products have emerged that provide soy-based DCAs. Some of these are based on whole (cooked and milled) soy beans, other rely on soy protein preparations. However, plant-based proteins are still relative scarcely applied in the field of creams. Furthermore, plant-based proteins have an entire different behaviour in oil-in-water emulsions than their dairy counterparts. These disadvantage have been countered using a wide variety of thickeners, emulsifiers and specific fat blends, often using more exotic and/or hardened fats, fully synthetic emulsifiers and foaming agents in order to obtain a product that is acceptable to a consumer.

With a strongly increasing demand for plant-based foods, there is a need to provide creams that better meet the demand for ‘naturalness’, having reduced levels of emulsifiers and thickeners of a synthetic origin and replacing them with more nature-derived alternatives, while also non-hardened fats are preferred

### SUMMARY OF THE INVENTION

Since it is desirable that plant-based cream compositions can be used in a wide range of applications, there is a need for a formulation that can be used for a broad range of purposes without defects. Thus, a plant-based multipurpose and/ or whippable composition should combine good behaviour in many different applications. That is, a multipurpose and/or whippable composition should meet as many as possible of the following requirements:
no off-taste, neutral taste
a neutral pH
good whippability when whipped
little post-hardening of the whipped product
good stability of the whipped product at room temperature
good stability against aggregation when heated when used as an additive (without whipping)
good stability against aggregation when used as an additive at low pH (both at low and at high temperature)

Hence it is an objective of the present invention to provide for a neutral edible oil-in-water emulsion composition that is usable as a multipurpose and/or whippable composition. It is a further objective of the present invention to provide for a neutral edible oil-in-water emulsion composition that fulfils as many as possible of the above requirements for a multipurpose and/or whippable composition. It is another objective of the present invention to provide for a neutral edible oil-in-water emulsion composition which can be applied in a wide range of dishes and foodstuffs without the occurrence of defects, preferably within a wide range of temperatures. Furthermore, it is a particular objective of the present invention to provide for a neutral edible oil-in-water composition that has both good whipping properties and does not show aggregation or coagulation in hot acidic foodstuffs such as sour soups or wine sauces.

Multipurpose and/or whippable cream compositions were conventionally prepared with fat blends such as PK38, hydrogenated palm kernel stearin fraction having a slip melting point of 38° Celsius, or even fully hydrogenated palm kernel stearin fraction having a slip melting point of 39° Celsius, PK39. Nowadays there is a preference for non-hydrogenated fat fractions. In the art, alternative fat blends have been developed based on mixtures of palm oil stearin fractions and palm kernel stearin fractions that avoided the use of hydrogenated fats. Often these fat blends require the use of emulsifiers and thickeners in order to come to the desired whippability, viscosity and applicability as multipurpose creams. The present inventors have found that the use of certain plant-based proteins allow for the preparation of improved edible multipurpose and/or whippable oil-in-water emulsions. The inventors also found that making emulsions based on plant-based proteins profited from redesign of the other constituting components as well. Simple substitution of dairy protein with plant-based protein led to undesirable viscosities and structures for multipurpose and/or whippable cream compositions, also after temperature stabilisation.

The plant-based proteins can be used in lower amounts than conventional proteins and in certain embodiments can be used in combination with certain fat blends in the substantial absence or reduced amounts of other emulsifiers or thickeners.

We have found that one or more of these objectives can be met by our invention. Our invention shows that edible oil-in-water emulsion compositions comprising a plant-based protein meet the objectives stated above. In particular, edible oil-in-water emulsion compositions according to this invention can be made that are whippable and/or do not aggregate or coagulate upon use without whipping in hot acidic media such as sour Polish-style tomato soup or white wine sauce. As such, some of the emulsions of the present invention are suitable for a multipurpose cream. Some of the emulsions of the present invention are suitable as a whipping cream when whipped, but can be less useful as a multipurpose cream.

Accordingly, in a first aspect the present invention provides an oil-in-water emulsion comprising a fat phase, a water phase and a plant-based protein.

A second aspect of the invention is a process to prepare the edible oil-in-water emulsion composition.

A third aspect of the invention is a whipping cream (suitable for whipping) comprising an emulsion of the invention.

A third aspect of the invention is a multipurpose cream (preferably suitable for cooking) comprising an emulsion of the invention.

A fourth aspect of the invention is the use of an edible oil-in-water emulsion composition according to the present invention as a whipping cream and/or as a multipurpose cream.

A fifth aspect of the invention is the use of an edible oil-in-water emulsion composition according to the first aspect of the invention as an additive in a food product, preferably in a liquid food product or a solid or solidifiable food product.

A further aspect of the invention resides in the use of a plant-based protein in a water-in-oil emulsion.

### DETAILED DESCRIPTION OF THE INVENTION

All percentages are weight/weight percentages unless otherwise indicated. Except in the examples, or where otherwise explicitly indicated, all numbers in this description indicating amounts of material or conditions of reaction, physical properties of materials and/or use are to be understood as modified by the word “about”. Unless specified otherwise, numerical ranges expressed in the format “from x to y” are understood to include x and y. When for a specific feature multiple preferred ranges are described in the format “from x to y”, it is understood that all ranges combining the different endpoints are also contemplated.

For the purpose of the invention, ambient temperature is defined as a temperature of about 20-25° Celsius. The terms ‘oil’ and ‘fat’ are used interchangeably unless specified otherwise and concern edible oils and fats. Where applicable the prefix ‘liquid’ or ‘solid’ is added to indicate if the fat or oil is liquid or solid at ambient temperature as understood by the person skilled in the art.

The present invention relates to an edible oil-in-water emulsion composition.

Preferably, the present invention relates to an edible water-in-oil emulsion which is a multipurpose and/or whippable composition and can be seen as a dairy cream alternative (DCA) composition. For the purpose of this invention, a dairy cream alternative (DCA) composition is considered to be a multipurpose DCA composition, if it can be used for many different applications, ranging a similar scope as the application of a multipurpose dairy cream. For instance, a multipurpose DCA can be applicable as a whipping cream and as an additive (without whipping) in the same way as described above for dairy cream, without the occurrence of defects such as buttering, phase separation, aggregation or coagulation.

In addition, to meet consumer expectations of a multipurpose Product, it is preferred that the product of the invention has a neutral taste (not acidic), since real dairy cream has a neutral pH. Therefore, the edible emulsion composition of the present invention preferably has a pH of between 5.5 and 9 more preferable between 6 and 8, even more preferable between 6.5 and 7.5. A composition with a pH outside these ranges can be severely limited in its potential applications and might lead to defects in some potential applications. Hence, a composition with a pH outside these ranges may not be acceptable to consumers and professionals as a multipurpose composition. These are hence less preferred

Accordingly, in a first aspect the present invention provides an oil-in-water emulsion comprising a fat phase, a water phase and plant-based protein. comprising (wt. % drawn on the total composition):
10-50 wt. % of an fat phase;
at least 45 wt. % of a water phase, and
   wherein the emulsion further comprises 0.01-10 wt. % of a plant-based-protein.

We now describe the various elements (fats, proteins, protein content and embodiments that make up the invention. It is noted that in order to capture the full relevance of the invention, the various elements each have their own embodiments and variants. It is noted that various (preferred) embodiments of one element can be combined with can be combined with various (preferred) embodiments of another element without adding subject matter. These combinations are considered within the present invention.

### Fats and Oils

The fat phase is an essential element of the edible emulsion of the invention. Such a fat phase typically comprises edible fats and oils.

The edible oil-in-water emulsion composition of the present invention comprises 10 to 50 wt. % of a fat phase (wt. % drawn on the total emulsion). The edible oil-in-water emulsion composition of the present invention preferably comprises 20 to 45 wt. %, more preferably 25 to 40 wt. %, and still more preferably 28 to 37% of a fat phase.

There is a strong preference for non-hydrogenated fats and oils. Non-hydrogenated means that the fat or oil has not undergone any hydrogenation treatment. Preferably, the oils and fats in the fat phase contains at most 0.01 wt. % hydrogenated fat (wt. % drawn on the total fat phase), preferably no hydrogenated fat. This entails the starting ingredients as well as blends and interesterified mixtures and even fractions of fats. Non-hydrogenated fats have essentially no trans-fatty acids.

The fat phase preferably comprises a sufficient amount of solid fat at low temperatures in order to yield a desired emulsion composition. Simultaneously, in order to instil desirable organoleptic properties in terms of mouthfeel and appearance, the fat phase preferably essentially melts in the mouth upon consumption. These solid fat contents are given in wt. % with respect to the fat phase.

### Solid Fat Content

The solid fat content (SFC) in this description and claims is expressed as N-value, essentially as defined in Fette, Seifen Anstrichmittel 8J) 180-186 (1978). The stabilisation profile applied is heating to a temperature of 80° C., keeping the oil for at least 10 minutes at 60° C. or higher, keeping the oil for 16 hours at 0° C. and then 30 minutes at the measuring temperature, except where indicated otherwise. A suitable way to determine the solid fat content of an oil-in-water emulsion is by NMR using standard pulse methods.

### Sources of Fat and Oils

A suitable fat phase may be derived from many different fat sources, including e.g. animal fats such as e.g. milk fat.

The fat phase of the edible oil-in-water emulsion composition according to the present invention preferably comprises vegetable oil or vegetable fat or a combination thereof. It is preferred that the fat phase consists of vegetable oils and fats. The vegetable fats or oils may suitably be derived from coconut oil, palm oil, palm kernel oil, rapeseed oil, linseed oil, soy bean oil, maize oil, sunflower oil, or mixtures thereof.

The fat phase of the emulsion of the invention may comprise a liquid oil fraction and a (solid) fat fraction.

### Liquid Oil Fraction

The fat phase may comprise from 0 (absent) up to 70 wt. % of liquid oil, drawn on the fat phase, preferably from 30 to 60 wt. %, more preferably from 35 to 50 wt. %.

The liquid oil fraction can be an element of the fat phase of the edible composition.

The liquid oil fraction can be selected from the group consisting of rapeseed oil, linseed oil, soy bean oil, maize oil, sunflower oil, or mixtures thereof, preferably selected from the group consisting of rapeseed oil and sunflower oil and mixtures thereof. There are embodiments in which there is no liquid oil and wherein the fat fraction hence constitutes the fat phase.

### Fat Fraction

The fat fraction or structuring fat fraction is an element of the fat phase of the edible composition.

The fat phase may comprise from 30 to 100 wt. % of fat fraction (wt. % drawn on the fat phase), preferably from 40 to 70 wt. %, more preferably from 50 to 65 wt. %.

The fat fraction can be characterized by solid fat content (SFC):

| ° C. | From (wt. %) | To wt. % |
|---|---|---|
| 10 | 40 | 65 |
| 20 | 20 | 40 |
| 30 | 3 | 15 |
| 35 | 0 | 10 |

The fat fraction can also be characterized by a triacylglyceride or TAG profile.

In the TAG profile the following abbreviations are used:

| | |
|---|---|
| M | Medium chain fatty acid (<=C14) |
| H | Saturated long chain fatty acid >= C16 |
| P | Palmitic acid C16:0 |
| S | Stearic acid, C18:0 |
| U | Unsaturated fatty acid |
| O | Oleic acid C18:1 |
| L | Linoleic acid/linolenic acid C18:2, C18:3 |
| HUH | Symmetrical triglyceride |
| H2U | Disaturated triglyceride |
| HU2 | Monosaturated triglyceride |
| U3 | Unsaturated triglyceride |
| H3 | Long chain fatty acid triglyceride |
| H2M | Mixed (2 long, 1 medium) chain fatty acid triglyceride |
| M3 | Medium chain fatty acid triglyceride |

In the fat fraction of the present invention, the sum of H3+H2M+H2U triglycerides is in the range of 5-25 wt. %, preferably from 6-23 wt. %, more preferably in the range of 7-20 (wt. % drawn on the total fat phase).

In the fat fraction of the present invention, the ratio of H3+H2M+H2U triglycerides to HM2+M3 triglycerides (HM2+M3)/(H3+H2M+H2U) is in the range of 2-4, preferably from 2.1-3.8, more preferably from 2.2-3.5, drawn on the total fat phase.

In an alternative embodiment of an emulsion of the invention, preferably in combination with an embodiment wherein a non-soy protein (all proteins listed here elsewhere with the exception of soy) is used, the ratio of H3+H2M+H2U triglycerides to HM2+M3 triglycerides (HM2+M3)/(H3+H2M+H2U) is in the range of 0.1-4.7 preferably from 0.5-4.5, more preferably from 1.0-4.3, most preferably from 1.5-4.2 drawn on the total fat phase.

In an alternative embodiment of an emulsion of the invention, in combination with an embodiment wherein a soy protein is used, the ratio of H3+H2M+H2U triglycerides to HM2+M3 triglycerides ((HM2+M3)/(H3+H2M+H2U) is in the range of 1.5-4.7 preferably from 2.0-4.5, more preferably from 2.3-4.3, most preferably from 2.5-4.2 drawn on the total fat phase.

### Fat Fraction Components

The fat fraction may comprise palm oil, wherein the palm oil is preferably palm oil stearin, more preferably multi fractionated palm oil stearin.

The fat fraction may comprise palm kernel oil, preferably palm kernel oil stearin.

The fat fraction may comprise a mixture of palm oil, preferably palm oil stearin, more preferably multi fractionated palm oil stearin together with palm kernel oil, preferably palm kernel oil stearin.

The fat fraction may comprise an interesterified mixture of palm oil, preferably palm oil stearin, more preferably multi fractionated palm oil stearin together with palm kernel oil, preferably palm kernel oil stearin. The interesterified mixture may be a 10:1 to 1:10 mixture of multi fractionated palm oil stearin and palm kernel oil.

The interesterified mixture may contain, drawn on the interesterified mixture,
a. 80-99 wt. %, preferably 85-95 wt. %, more preferably 90 wt. % of palm kernel oil, preferably palm kernel oil stearin; and
b. 1-20 wt. %, preferably 5-15, more preferably 10 wt. % of palm oil, preferably palm oil stearin, more preferably multi fractionated palm oil stearin.

The fat fraction may contains, drawn on the fat fraction:
a. 80-99 wt. % preferably 85-95 wt. %, more preferably 90 wt. % of the interesterified mixture; and
b. 1-20 wt. %, preferably 5-15 wt. %, more preferably 10 wt. % palm oil/multi fractionated palm oil stearin.

In a first alternative embodiment, the fat fraction may comprise (wt. % drawn on the fat fraction) a mixture of 40-95 wt. % of the interesterified mixture combined with one or more of
5-30 wt. %, preferably 10-20 wt. % of a multi fractionated palm oil stearin;
5-30 wt. %, preferably 10-20 wt. % of a dry fractionated palm oil stearin with a melting point of 52° C.;
5-30 wt. %, preferably 10-20 wt. % palm kernel stearin;
15-35 wt. %, preferably 20-30 wt. % palm kernel oil;
20-50 wt. %, preferably 25-35 wt. % of inES28, an interesterified mixture of 65 wt. % dry fractionated palm oil stearin with an MP of 52° C. and 35wt. % palm kernel oil.

In a second alternative embodiment, the fat fraction may comprise a combination of palm kernel, preferably palm kernel stearin in combination with palm oil stearin, more preferably multi fractionated palm oil stearin. In particular a combination of 40-60 wt. %, preferably 45-50 wt. % palm kernel stearin and 5-25 wt. %, preferably 10-20 wt. % multi fractionated palm oil stearin.

Good emulsions have been obtained with 30-60 wt. % oil phase (preferably selected from rapeseed and/or sunflower oil) and 40-70 wt. % fat fraction, wt. % drawn on the total fat phase, wherein the fat fraction is the first and/or the second alternative embodiment.

### Proteins

Proteins are an essential element of the emulsion of the invention, since they impart desirable structure, taste and stabilising properties to the oil-in-water emulsion compositions and may enhance or contribute to application parameters such as whippability, hardening or acid stability of the emulsion.

### Plant-based Proteins

The essential protein in this invention is a plant-based protein. A plant-based protein is obtained from plants, including parts such as fruits or seeds, leaves, stems, roots etc. The plant-based protein of the present invention can be selected from amongst legumes, oil seeds, nuts and cereals.

The plant-based protein of the present invention, has an average molecular weight in the range of 50-500 kDa (kiloDalton or a Molecular weight (SI-unit) of 50,000 to 500,000), preferably from 100-400 kDA, more preferably from 125-300 kDa.

The plant-based protein can be from a legume, wherein the legume is selected from the group consisting of Alfalfa (Medicago sativa), clover (Trifolium), tamarind (Tamarindus indica), Kidney bean, navy bean, pinto bean, black turtle bean, haricot bean, (Phaseolus vulgaris), Lima bean, butter bean (Phaseolus lunatus), Adzuki bean, azuki bean (Vigna angularis), Mung bean, golden gram, green gram (Vigna radiata), Black gram, urad (Vigna mungo), Scarlet runner bean (Phaseolus coccineus), Ricebean (Vigna umbellata), Moth bean (Vigna aconitifolia), Tepary bean (Phaseolus acutifolius), Horse bean (Vicia faba equina), Broad bean (Vicia faba), Field bean (Vicia faba), Garden pea (Pisum sativum var. sativum), Protein pea (Pisum sativum var. arvense), Chickpea, garbanzo, Bengal gram (Cicer arietinum), Dry cowpea, black-eyed pea, blackeye bean (Vigna unguiculata), Pigeon pea, Arhar/Toor, cajan pea, Congo bean, andules, (Cajanus cajan), Lentil (Lens culinaris), Bambara groundnut, earth pea (Vigna subterranea), Vetch, common vetch (Vicia sativa), Lupins (Lupinus spp.), Lablab, hyacinth bean (Lablab purpureus), Jack bean (Canavalia ensiformis), sword bean (Canavalia gladiata), Winged bean (Psophocarpus tetragonolobus), Velvet bean, cowitch (Mucuna pruriens var. utilis), Yam bean (Pachyrhizus erosus).

There is a preference for a legume selected from the group consisting of Garden pea (Pisum sativum var. sativum), Protein pea (Pisum sativum var. arvense), Horse bean (Vicia faba equina), Broad bean (Vicia faba), Field bean (Vicia faba), Chickpea (Cicer arietinum), Lentil (Lens culinaris).

There is a distinct preference for a legume selected from the group consisting of Horse bean (Vicia faba equina), Broad bean (Vicia faba), Field bean (Vicia faba), Lentil (Lens culinaris), The most preferred legumes are Broad bean (Vicia faba), Field bean (Vicia faba) and Lentil (Lens culinaris).

The plant-based protein can be from an oil seed, wherein the oil seed is selected from the group consisting of soybean (Glycine max), cotton seed, peanut (Arachis hypogaea), sunflower (helianthus), canola (B. napus subsp. napus), coconut (Cocos nucifera). There is a preference for an oil seed selected from the group consisting of sunflower (helianthus), canola (B. napus subsp. napus).

The most preferred oil seed is sunflower (helianthus).

The plant-based protein can be from a nut, wherein the nut is selected from the group consisting of almond (Prunus dulcis, syn. Prunus amygdalus), brazil nut (Bertholletia excelsa), hazel nut (Corylus avellana), walnut (Juglandaceae), pecan nut (Carya illinoinensis), candle nut (Aleurites moluccanus, cashew nut (Anacardium occidentale), chestnut (Castanea), macadamia nut (Macadamia), mongongo (Schinziophyton rautanenii), pili nut (Canarium ovatum), pine nut (pinaceae), pistachio nut (Pistacia vera), yeheb nut (Cordeauxia edulis).

There is a preference selected from the group consisting of almond (Prunus dulcis, syn. Prunus amygdalus), hazel nut (Corylus avellana), walnut (Juglandaceae), pecan nut (Carya illinoinensis), mongongo (Schinziophyton rautanenii), pili nut (Canarium ovatum), pine nut (pinaceae), pistachio nut (Pistacia vera), yeheb nut (Cordeauxia edulis).

There is a distinct preference where the nut is almond (Prunus dulcis, syn. Prunus amygdalus).

The plant-based protein can be from a cereal, wherein the cereal is selected from the group consisting of oat (Avena sativa), amaranth (Amaranthus), barley (Hordeum vulgare), Rice (oryza sativa, oryza glaberrima), buckwheat (Fagopyrum esculentum), corn (Zea mays subsp. mays), millet, quinoa (Chenopodium quinoa), Rye (Secale cereale), sorghum (Sorghum), spelt, teff, triticale,

There is a preference for a cereal selected from the group consisting of wheat (Triticum), Oat (Avena sativa), barley (Hordeum vulgare),

There is a distinct preference where the cereal is wheat (Triticum).

The plant-based protein can be isolated from the plant or parts thereof in the form of a plant-based protein isolate or concentrate. A plant-based protein isolate or concentrate contains plant-based proteins but may also contain other plant-based elements, depending on the origin of the plant material and the method of obtaining the isolate or concentrate. The plant-based protein in the emulsion of the invention can be in the form of a plant-based protein itself or in the form of an isolate or concentrate comprising the plant-based protein. Thus, in a preferred embodiment of this element of the invention, the plant-based protein is in the form of an plant-based protein isolate or concentrate. Typically, the plant-based protein isolate or concentrate contains plant-based protein in an amount of 20-80 wt. %, but varies per type of plant. It was found that the protein (isolate or concentrate) was capable of providing desired and preferred characteristics to the water in oil emulsion of the invention.

In one embodiment of the invention, the legume plant-based protein isolate contains legume plant-based protein in an amount of 50-80 wt. %

In one embodiment of the invention, the oil seed plant-based protein isolate contains oil seed plant-based protein in an amount of 40-70 wt. %

In one embodiment of the invention, the nut plant-based protein isolate contains nut plant-based protein in an amount of 50-80 wt. % In one embodiment of the invention, the cereal plant-based protein isolate contains cereal plant-based protein in an amount of 20-60 wt. %

In the edible oil-in-water emulsion of the invention, the plant-based protein is present in an amount of 0.01 to 10 wt. % of the total composition, preferably 0.2-5 wt. %, more preferably 0.3-3, most preferably from 0.4-1.5 wt. %. The plant-based protein can be provided in the form of a plant-based protein isolate in amounts that correspond to the amount of plant-based protein that is present in the specific plant-based protein isolate as indicated herein.

A plant-based protein isolate (containing a plant-based protein) can be present in an amount of 0.1 to 15 wt. % of the total composition, preferably 0.2-10 wt. %, more preferably 0.5-3, most preferably from 0.75-1.5 wt. %

Thus, for a legume plant-based protein, an legume plant-based protein isolate that contains 70 wt. % of legume plant-based protein, the legume plant-based protein is present in the emulsion an amount of from 0.07 wt. % (0.1 wt. %*70wt. %) to 10.5 wt. % (15 wt. %*70 wt. %). For other plant-based proteins and plant-based protein isolates analogous calculations are within the abilities of the average skilled person.

Good results in terms of the edible emulsions of the present invention have been obtained with plant-based proteins or isolates from broad bean (Vicia faba), Chickpea (Cicer arietinum), Lentil (Lens culinaris), canola (B. napus subsp. napus) and/or almond (Prunus dulcis, syn. Prunus amygdalus) protein isolates, preferably in an amount of 0.5-1.5 wt. % protein isolate drawn on the total emulsion.

Therefore, the proteins included in the edible oil-in-water emulsion composition according to the present invention preferably comprise (and more preferably (substantially) consist of) broad bean (Vicia faba), Chickpea (Cicer arietinum), Lentil (Lens culinaris), canola (B. napus subsp. napus) and/or almond (Prunus dulcis, syn. Prunus amygdalus) proteins. Preferably, the protein comprised in the oil-in-water emulsion composition of the present invention substantially consists (up to 99 wt. %, drawn on the total amount of plant-based protein in the emulsion) of broad bean (Vicia faba), Chickpea (Cicer arietinum), Lentil (Lens culinaris), canola (B. napus subsp. napus) and/or almond (Prunus dulcis, syn. Prunus amygdalus) proteins.

It was found that that edible oil in water emulsions could be prepared using the plant-based proteins described herein. the emulsions can be suitably used a multipurpose creams and/or as whipped creams with the preferred plant-based proteins of broad bean (Vicia faba), Chickpea (Cicer arietinum), Lentil (Lens culinaris), canola (B. napus subsp. napus) and/or almond (Prunus dulcis, syn. Prunus amygdalus) where these proteins provide up to 60 wt. % of the total protein fraction.

We have found that the proteins are functional for obtaining a satisfactory multipurpose DCA. In particular, they impart the right whippability characteristics to the dairy cream alternative and/or provide the necessary stability in case of a multipurpose cream. Moreover, they contribute to the taste and stability of the emulsion.

Below the lower boundary, the behaviour of the composition upon whipping gets unpredictable in terms of firmness, whipping time and further processability. Such unpredictability is extremely undesirable to professional and domestic users of Products. Moreover, if the protein content of the composition is below the lower boundary, the composition does not exhibit the rich and creamy taste that consumers require of a DCA. Above the specified upper boundary, the excess of protein leads to an emulsion that is too thick. In general, in such cases, even a premix of the constituents can have too high a viscosity to be able to be processed into a homogenous oil-in-water emulsion.

It is observed that, in comparison with conventional (dairy)-based proteins, the amount of protein isolate in emulsions of the invention is significantly and unexpectedly lower. This means that less protein is needed for obtained adequate emulsions according to the invention in terms of whippability, viscosity, stability etc.

The proteins of the plant-based proteins described herein can also be characterised by their molecular weight range or by their lowest average molecular weight, expressed as kDa:

| | | Main | | mol | lowest |
|---|---|---|---|---|---|
| | | protein | Protein | weight | Av. MW |
| Class | Example | type | Level | (kDa) | (kDa) |
| Animal protein | Milk | Casein | 80% | 25-35 | 25 |
| (comparative) | | | | | |
| Nuts Protein | Almond | Amandin | 65% | 360 | 243 |
| Cereal Protein | Wheat | Glutenins | 40% | 30-90 | 29 |
| Legume protein | Faba | Legumin + | 70% | 200-380 | 148 |
| | Bean | Vicilin | | | |
| Oil seeds | Sunflower | Helianthinin | 60% | 300-350 | 190 |
| protein | seed | | | | |

Thus, in embodiments of the invention pertaining to emulsions containing plant-based proteins of a particular class, these can be characterised alternatively or additionally by their respective molecular weight range or by their lowest average molecular weight, expressed as kDa.

The use of the herein described plant-based proteins in the emulsion of the present invention allows for the formulation of emulsions in absence of further emulsifiers, thickeners etc., i.e. the plant-based protein isolate is the sole emulsifier present in the emulsion. Preferably, the amount of plant-based protein isolate is more than 80 wt. %, preferably more than 90 wt. %, more preferably more than 95wt. %, most preferably even more than 99 wt. % drawn on the total sum of emulsifiers and thickeners in the emulsion of the invention.

Thus, in a particular preferred embodiment of the invention, a multipurpose edible water in oil emulsion is provided containing a water phase, a fat phase and a plant-based protein isolate in absence of further proteins, emulsifiers, thickeners etc.

### Emulsifiers

An edible oil-in-water emulsion composition according to the present invention may also comprise other emulsifiers or mixtures of emulsifiers. For instance, substantially fat-soluble emulsifiers may improve the whipping properties of an emulsion composition. Therefore, an edible oil-in-water emulsion composition according the present invention may, in addition to the plant-based proteins described herein, further comprise 0.01 to 0.4 wt. % of fat-soluble emulsifiers, drawn on the total composition of the emulsion. Preferably, the fat-soluble emulsifiers are selected from monoglycerides, diglycerides, lecithins. There is a preference for small molecules emulsifiers with high hlb-values, like hlb-values above 12.

Monoglycerides and diglycerides are partial esters of fatty acid esters and glycerol. Lecithins may for instance be derived from egg lecithin, soy lecithin, or sunflower lecithin. Lecithins may be used in crude or in refined form. Similar substances like phospholipids or phophatidylcholines may also be used.

Lactic acid and tartaric esters of mono- and diglycerides of fatty acids are also known as Lactem or Dactem (foaming agents) are less preferred. Preferably the emulsion according to the invention does not contain such foaming agents. Preferably the emulsion of the invention contains only natural or nature derived emulsifiers, i.e. is free of fully synthetic emulsifiers such as polysorbates. It is even more preferred that the emulsion of the invention is emulsifier free

### Thickeners

Thickeners may be applied to further regulate the viscosity of the emulsion composition, or to suppress phase separation and/or creaming. Therefore, the edible oil-in-water emulsion composition according to the present invention may comprises 0.3 to 2.5 wt. % of thickeners, drawn on the total composition of the emulsion, preferably selected from starches and gums. The composition preferably comprises 0.3 to 2 wt. % starch and 0.01 to 0.5 wt. % gums, drawn on the total composition of the emulsion.

Starches may be derived from natural starches, including for instance maize, rice, tapioca or potato starches. The starches may also be selected from modified starches.

Gums may for instance be selected from gums like guar gum, locust bean gum, carrageenan, xanthan gum, agar agar, alginates and combinations thereof.

Preferably, the gums are selected from guar gum, locust bean gum, carrageenan and combinations thereof.

Other hydrocolloids or oligosaccharides with similar properties may also be applied, for instance pectins, gelatins, celluloses, collagens, or citrus fibres.

### Additional Ingredients

The edible oil-in-water emulsion composition according the present invention may also comprise any other common ingredients, for instance selected from sugars, sweeteners, flavourings, aroma compounds and combinations thereof, to improve the organoleptic properties and any other properties. Additionally, the oil-in-water emulsion composition may also comprise antioxidants or preservatives to improve its shelf-life.

### Properties

A multipurpose composition according to the present invention (i.e. containing a plant-based protein) can be a whipping cream alternative. Therefore, the edible oil-in-water emulsion composition according to the present invention is preferably whippable to an overrun of at least 120%, more preferably at least 150%.

Therefore, the present invention also relates to the composition according to the first aspect of our invention in the whipped state, having an overrun of at least 120%, more preferably at least 150%, and still more preferably between 150% and 250%.

The composition in the whipped state may also be used as an additive in foods.

A multipurpose composition preferably also is applicable as an additive without whipping in a wide variety of dishes and foodstuffs without showing defects. Therefore, the edible oil-in-water emulsion composition according to the present invention preferably does not aggregate or phase-separate upon dilution in a food product which may be heated and wherein the food product has a pH of between 3 and 8 (i.e. in the acidic range such as a white wine sauce or a polish soup). The food product may be a liquid food product. The composition preferably is applicable in acidic food products. Therefore, the food product may also have a pH of between 3 and 5.5, between 3.1 and 5 or between 3.3 and 4.5. The food product preferably has a temperature between about minus 20° C. and about 120° C., more preferably between 0° C. and 100° C., yet more preferably between 20° C. and 100° C. and even more preferably between 60° C. and 100° C.

### Process

The invention also relates to a process for manufacturing the edible oil-in-water emulsion composition, comprising the steps of
a. providing an aqueous phase comprising the plant-based protein,
b. providing a fat phase, and
c. mixing the aqueous phase and the fat phase and homogenising the mixture to an edible emulsion.

The aqueous phase preferably comprises water, the proteins, and (if present) any other water-soluble or easily dispersible constituents, like for instance gums, starches, water-soluble emulsifiers, sugar etc. The fat phase preferably comprises the fats and oils, (if present) fat-soluble emulsifiers and any other fat-soluble constituents.

The process according to the present invention may also include a pasteurisation or sterilisation process, to enhance the shelf life of the product. Homogenisation may also include a high-pressure homogenisation process. After preparation, the edible emulsion may for instance be hot-filled or cold-filled into suitable containers.

### Use

The composition of the edible oil-in-water emulsion composition, makes it applicable as a multipurpose composition. Therefore, according an aspect of the invention, the present invention also relates to use of an edible oil-in-water emulsion composition according to the present invention as a whipping cream. A whipping cream can yield whipped creams that are sufficiently aerated and sufficiently firm. Therefore, the invention preferably relates to use of an edible oil-in-water emulsion composition according to the present invention to create a whipped cream with an overrun of at least 40 or 50%, preferably at least 100%, more preferably at least 150%, and even more preferably between 150% and 250% and a Stevens value of preferably at least 35, more preferably at least 70.

Upon whipping, the composition may increase in stiffness and, upon aeration, in volume. Usage may also include combination of the composition in whipped state with other ingredients, like fruit juice, chocolate etc., or applying the whipped cream as topping, for piping, mousses etc.

When used as a whipped cream, the composition of the present invention advantageously displays many desirable properties: It shows little or no post-hardening upon storage at 5° C. for 24 hours. Post-hardening is an increase of the firmness beyond what is considered acceptable by consumers. The composition also shows good room temperature stability against post-hardening, or softening and syneresis, and good shape retention upon piping. These properties are even maintained when for instance an acidic fruit puree is folded into the whipped cream.

Here, syneresis indicates the loss of fluid from the whipped cream, e.g. by droplet formation, or expulsion, precipitation or leaking of fluid from the whipped cream.

According to another aspect of the invention, the present invention also relates to use of an edible oil-in-water emulsion composition according the present invention as an additive in a food product, preferably a liquid food product or a solid or solidifiable food product. Thus, the composition may be added for instance to hot beverages such as coffee or tea, or to soups or oven dishes. The composition can also be used in solidifiable food products such as cake batters, puddings, creme brûlees, panacottas, omelettes, gratins, ice creams etc. The composition may also be used as a topping, for instance on cakes, pies or puddings.

The multipurpose composition according to the present invention in particular shows excellent properties as an additive in a wide variety of dishes and foodstuffs with challenging conditions without showing defects. That is, the stability of the oil-in-water emulsion composition of the present invention is not much affected by pH or temperature within a range usually encountered for foodstuffs. Therefore, the present invention preferably also relates to the use of an edible oil-in-water emulsion composition according to the present invention as an additive in a food product, wherein the food product has a pH of between 3 and 8 and preferably with a temperature of between minus 20° C. and 120° C.

The food product preferably has a pH of between 3 and 5.5, more preferably between 3.1 and 5 and even more preferably between 3.5 and 4.5. The food product preferably has a temperature between 0° C. and 100° C., more preferably between 20° C. and 100° C. and even more preferably between 60° C. and 100° C. Thus use according to this aspect of the invention also relates to use in acidic food products or hot or cold food products.

Preferably, the use of the edible oil-in-water emulsion composition according to the an aspect of the present invention relates to use as an additive in an acidic, creamy tomato soup, wherein the soup is preferably prepared by mixing water, tomato concentrate and stock, subsequently heating the mixture, preferably to 100° C., and mixing in from 5 to 50 wt. % of the edible oil-in-water emulsion composition in the soup, wt. % drawn on the soup.

Similarly preferably, such use of the edible oil-in-water emulsion composition according to the an aspect of the present invention also relates to use as an additive in an acidic reduction sauce, wherein the sauce preferably comprises white wine and the edible oil-in-water emulsion of the present invention and wherein the sauce is preferably prepared by a method comprising one or more, preferably two or more, reduction steps, wherein preferably at least one reduction step takes place before addition of the oil-in-water emulsion composition and at least one reduction step takes place after addition of the oil-in-water emulsion composition. A reduction step is characterised by a reduction of the volume and mass of the total sauce mixture by evaporation whilst heating. A reduction step typically involves a reduction in weight of 10 to 90% of the weight of the mixture before reduction. In the latter uses, the edible oil-in-water emulsion composition of the present invention in acidic liquid media advantageously does neither visibly flocculate nor aggregate. Thus, these demonstrate that the composition is a multipurpose composition.

The invention further relates to a whipping cream comprising an emulsion according to the invention.

The invention further relates to a multipurpose cream comprising an emulsion according to the invention.

The invention further relates to the use of an emulsion according to the present invention as a whipping cream.

The invention further relates to the use of an emulsion according to the present invention as a multipurpose cream.

The invention further relates to the use of a plant-based protein as defined herein elsewhere as a protein in a Non-Dairy Cream protein substitute.

The invention further relates to the use of an fat phase as defined herein elsewhere as a fat phase in a Non-Dairy Cream whippable cream and/ multipurpose cream.

### EXAMPLES

The invention is illustrated by the non-limiting examples and comparative examples described below.

### Preparation

For each emulsion, the preparation takes place by an emulsification process, comprising the following steps.
The fat-phase ingredients are combined in a suitable container heated to 60 to 80° C. and mixed until the mixture is clear.
In a separate container, the aqueous phase ingredients are added to water at 60 to 80° C.
The fat phase and the aqueous phase are combined, mixed with a high shear mixer for at least 5 minutes, and subsequently heated to 88° C.
The mixture is sterilised by treatment with steam (145° C.) for 4.8 seconds.
The emulsion thus obtained is cooled down to about 80° C. and homogenised (in a two-stage homogeniser) at a pressure of 100 bar.
The resulting sterilised and homogenised product is cooled to 8 to 10° C., packed into aseptic containers, sealed and stored at 5° C.

### Application Tests

The compositions described above are tested for their suitability as multipurpose dairy cream alternatives and/or whipping cream by means of the following application tests.

### Whippability

Typically, 0.5 to 1 litre of the emulsion composition is whipped using a professional mixer until the cream reached a maximum in volume and a sufficient firmness to adhere to the whisk. The whipping time required, and the Stevens value is recorded, as well as the obtained overrun.

Stevens values give an indication about the hardness (also called firmness) of a product. The Stevens value is determined according to the following protocol.

After stabilisation at either 5 or 20° Celsius the hardness of the product is analysed at the stabilisation temperature with a TA-XT2 Texture Analyser (Stable Micro Systems, Godalming, Surrey, UK) equipped with a perspex probe with a diameter of 25.4 mm. The probe is pushed into the product at a speed of 1 mm/s, from a distance of 4 mm. The force required is read from the digital display and is expressed in grams.

The overrun of the whipped composition is calculated from the following formula:

Overrun %=100×(V₂−V₁)/V₁

where V₁ is the volume of the emulsion composition before whipping and V₂ is the volume of the aerated emulsion composition upon whipping.

Whippability is considered acceptable if a Stevens value of about 30 to 120 and/or an overrun of at least 120% were measured.

### Room Temperature Stability of the Whipped Products

Room temperature stability of the whipped products is assessed by determining the Stevens values (as described above) at ambient temperature 2 hours after whipping. Also, rosettes which are piped from the whipped product immediately after whipping, are visually inspected after 4 hours for shape retention and occurrence of syneresis.

The room temperature stability of the product is considered acceptable if a Stevens value of between 10 and 30 is obtained and good if a Stevens value between 30 and 200 is measured and the piped rosettes retain their shape and do not show any sign of syneresis.

### Post-hardening of the Whipped Products

The occurrence of post-hardening (i.e. undesired hardening upon standing) of the whipped products is determined by measuring the Stevens values of the whipped product after storage at 5° C. for 2 hours and 24 hours respectively. The sample is cooled back to 5° C. prior to measurement.

Also, rosettes are piped from the whipped product immediately after whipping. The quality of the rosettes is assessed after storage at 5° C. for 4 hours and 24 hours respectively, by a three person expert panel. The product is considered acceptable if the rosettes (i) show good shape retention, (ii) are not crumbling and (iii) do not show substantial post-firming upon storage for 24 hours.

### Heat Stability of the Emulsion as an Additive

A mushroom sauce is prepared by frying 100 grams of sliced mushrooms in 20 grams of butter until the mushrooms are transparent. 25 grams of white wine is added to the hot mushrooms and allowed to reduce. After addition of 200 grams of jus de veau lié, the mixture is brought to the boil and reduced until about half the original volume. 100 Grams of the Product is added. Subsequently, the sauce is reduced to a desired thickness is reached (approximately half the original volume).

The quality of the sauce is assessed by a three person expert panel. The dairy cream alternative product is considered acceptable if (i) no grease drops are present on the finished sauce, (ii) no visible aggregation or flocculation of the DCA occurrs upon reduction of the sauce, and (iii) the sauce retains about the same thickness upon simmering at 85° C. for 3 hours. The thickness is assessed by direct observation.

### Heat Stability of the Emulsion as an Additive in Acidic Media

The heat stability of the emulsion composition as an additive in acidic media was tested by preparing an acidic Polish-style tomato soup and an acidic white wine reduction sauce.

### Polish-style Tomato Soup

A Polish-style tomato soup with a pH of about 4.3 is prepared by mixing 500 ml of water, 50 grams of tomato paste (28 to 30% concentrate) and 10 grams of chicken stock powder, and bringing the mixture to the boil whilst stirring. Subsequently, 50 grams of the Product is added to the boiling soup.

### Reduction Sauce

A white wine reduction sauce with a pH of about 3.16 is prepared by melting 5 grams of butter together with 75 grams of finely chopped shallots, adding 125 ml of white wine and reduction of the mixture with moderate heating until almost all water liquid has evaporated.

Subsequently, 125 ml of fish fond (Unilever Food Solutions Garde d'Or liquid fond or similar) is added and the mixture is reduced again, until about half the original volume. Finally, 300 ml of the product is added, and again the sauce is reduced until about half the original volume.

The quality of the soup and the sauce is assessed by a three person expert panel. The product is considered acceptable if (i) both the soup and the reduction sauce display a homogeneous creamy texture and (ii) the product does not aggregate or flocculate upon addition to both the soup mixture and the reduction sauce mixture and (iii) the product does not aggregate or flocculate upon final reduction of the sauce. Ratings are given from 1 (very good) to 5 (bad).

### Temperature Cycling Test

In a temperature cycling test, the product is subjected to a temperature program and various parameters are measured (viscosity, whippability, water layer, overrun etc.). The product is prepared and stored at 5° C., kept at 25° C. for 4 hours and kept at 25° C. for 48 hours. The product is cooled back 5 prior to each measurement. The product meets specifications when the product is pourable out of the packing and whippable with an overrun of >50%.

The product does not meet specification if the products cannot be poured out of the packaging (too viscous) and/or is non-whippable (overrun <50%).

### Rating of the Results

The results of the qualitative tests in are rated according to the following scheme:
++ good
+ acceptable
− not acceptable
nd not determined

TABLE 1
Abbreviations used

| | |
|---|---|
| PKs | palm kernel stearin |
| SF | Sun flower oil |
| RP | Rape seed oil |
| ELM 2 | IN90(90PKS/10mfPOsIV14))/10mfPOsIV14: |
| | 90 wt. % of an interesterified |
| | mixture of 90 wt. % PKS and |
| | 10 wt. % mfPOsIV14 with |
| | 10 wt. % mfPOsIV14 |
| FBP | Faba bean protein isolate |
| Red PO | Colorant |
| SF lec | Sun flower lecithin |
| CN | Coconut Oil |
| PK38: | Hydrogenated palm Kernel oil, slip |
| | melting point 38 |
| PK39 | Fully Hydrogenated Palm Kernel Oil, |
| | slip melting point 39 |
| mfPOs: | multi fractionated Palm Oil solid fraction |
| | (2x solid super stearin) |
| IV14 | Iodine Value = 14 |

### Materials

Fava Bean Protein Isolate was obtained from AGT Foods, Canada

Lentil Protein Isolate was obtained from AGT Foods, Canada

Chickpea Protein Isolate was obtained from AGT Foods, Canada

Canola Protein Isolate was obtained from DSM, the Netherlands

Almond Protein Isolate was obtained from Blue Diamond Almonds, USA

### Fat Blends

Fats were obtained from a variety of suppliers and were blended into mixtures with the following specifications:

| | | H3 + | (HM2 + M3)/ |
|---|---|---|---|
| | Fatblend | H2U + H2M | (H3 + H2U + H2M) |
| 1 | 100CN | 1.7 | 24 |
| 2 | 40ELM2/60CN | 9.6 | 4.8 |
| 3 | 50ELM2/50CN | 6.9 | 7 |
| 4 | 60PK38/40CN | 10.3 | 4.4 |
| 5 | 60ELM2/40CN | 13.5 | 3.6 |
| 6 | 60ELM2/40RP | 9.7 | 3.5 |
| 7 | PK39 | 13.6 | 4.2 |
| 8 | 48PKs//40RP12mfPOs(IV14) | 12.3 | 2.7 |
| 9 | 70ELM2/30SF | 14.4 | 2.7 |
| 10 | 100 ELM2 | 20.6 | 2.7 |

### Emulsions

| | | Emulsions | Emulsions |
|---|---|---|---|
| | | with DAIRY | with PLANT |
| | Fatblend | protein | protein |
| 1 | 100CN | + | − |
| 2 | 40ELM2/60CN | ++ | − |
| 3 | 50ELM2/50CN | ++ | − |
| 4 | 60PK38/40CN | ++ | +/− |
| 5 | 60ELM2/40CN | ++ | + |
| 6 | 60ELM2/40RP | ++ | ++ |
| 7 | PK39 | + | + |
| 8 | 48PKs//40RP12mfPOs(IV14) | ++ | ++ |
| 9 | 70ELM2/30SF | ++ | ++ |
| 10 | 100 ELM2 | ++ | ++ |

Emulsions were prepared in a conventional manner by using 30 wt. % of the fat blend, 2.4 wt. % of dairy protein or 0.6 wt % of faba bean protein based on 1 wt. % of faba bean protein isolate.

The emulsion were tested base on the temperature cycling test by determining pourability and whippability after 4 h 25° C. cycling and cooling to 5° C.

Fat blends 4, 5, 6, 7, 8, 9 and 10 gave good results in oil-in water emulsions with plant proteins. Fat blends 4 and 7 are fat blends contain hydrogenated fats. Blends 5, 6 and 8 are non-hydrogenated fat blends that yield good emulsions.

### Compositions

The following compositions were prepared and tested in accordance with the above protocols:

| Protein (as | Min Avg | | | Qualitative | | 4 h cycle |
|---|---|---|---|---|---|---|
| isolate) | MW > kDa | Wt. % | Oil phase | emulsion | Whippable | stable |
| Faba bean | 148 | 0.60% | 30% 60ELM2/40RP | ++ | ++ | ++ |
| Lentil | 148 | 0.60% | 30% 60ELM2/40RP | ++ | ++ | ++ |
| Chickpea | 148 | 0.60% | 30% 60ELM2/40RP | ++ | ++ | ++ |
| Canola | 190 | 0.60% | 30% 60ELM2/40RP | + | ++ | ++ |
| Almond | 234 | 0.60% | 30% 60ELM2/40RP | ++ | ++ | ++ |

The model formulations compositions containing Vicia faba protein isolate according to the invention are in Table 3:

TABLE 3

| | | Model formulations | | | |
|---|---|---|---|---|---|
| | | EX 1 | EX 2 | EX 3 | EX 4 |
| | Ingredients | wt % | wt % | wt % | wt % |
| Aqueous | | 456 | 509 | 604 | 601 |
| phase | Plant protein | 1 ¹⁾ | 1 ¹⁾ | 1 ¹⁾ | 1.09 ²⁾ |
| | SF lec | — | 0.05 | — | — |
| | SE | — | 0.3 | — | — |
| | Purity VL | — | 0.65 | — | — |
| | (modified starch) | | | | |
| | Delitex | — | — | — | — |
| | (modified starch) | | | | |
| | Xantan Gum | — | — | — | — |
| | Guar Gum | — | 0.06 | — | — |

| | | | | |
|---|---|---|---|---|
| Fat blend | 6 | 6 | 6 | 10 |
| protein content (wt %) | 0.6 | 0.6 | 0.6 | 0.55 |

¹⁾ Vicia faba protein isolate
²⁾ Lentil protein concentrate

TABLE 4
Whipping 5° C.

| Invention example | Whipping time (min) | Over run (%) | Firmness |
|---|---|---|---|
| Ex 1 | 2.5/3.5 | 159/77 | 65.5/123.9 |
| Ex 2 | 3.50 | 237 | 19.5 |
| Ex 3 | 2.00 | 174 | 29.1 |
| Ex 4 | 2.00 | 138 | 59.5 |

TABLE 5
Whipping after a temperature cycling test at 25° C. for 4 hours.

| Invention | Whipping | Overrun | | |
|---|---|---|---|---|
| example | time (min) | (%) | Firmness | Viscosity |
| Ex 1 | 1.67 | 172 | Nd | 37 |
| Ex 2 | 1.75 | 221 | nd | 120 |
| Ex 3 | 1.50 | 146 | 76.3 | |
| Ex 4 | 1.00 | 144 | 94 | 54 |

TABLE 6
Heat stability

| Invention example | White wine | Tomato soup |
|---|---|---|
| Ex 2 | 1 | 1 |

1. An edible oil-in-water emulsion comprising a vegetable, non-hydrogenated fat phase, a water phase and a plant-based protein comprising (wt. % drawn on the total composition):
10-50 wt. % of a fat phase; and
at least 45 wt. % of a water phase,
wherein the emulsion further comprises 0.01-10 wt. % of a plant-based-protein, and wherein the sum of H3+H2M+H2U triglycerides is in the range of 5-25 wt. %.

2. The edible oil-in-water emulsion according to claim 1 wherein the plant-based protein has an average molecular weight in the range of 50-500.

3. The edible oil-in-water emulsion according to claim 1, wherein the plant-based protein is selected from the group consisting of legumes, oil seeds, nuts and cereals.

4. The edible oil-in-water emulsion according to claim 1, wherein the plant-based protein is from Broad bean (Vicia faba), Chickpea (Cicer arietinum), Lentil (Lens culinaris), Canola (B. napus subsp. napus) and/or almond (Prunus dulcis, syn. Prunus amygdalus).

5. The edible oil-in-water emulsion according to claim 1, wherein the plant-based protein is in the form of a plant-based protein isolate or concentrate.

6. The edible oil-in-water emulsion according to claim 1, wherein the fat phase is present in an amount of 25-45 wt. % of the total composition,

7. The edible oil-in-water emulsion according to claim 1, wherein the fat phase comprises 30 to 100 wt. % of a fat fraction, drawn on the fat phase,

8. The edible oil-in-water emulsion according to claim 1, wherein the ratio of H3+H2M+H2U triglycerides to HM2+M3 triglycerides is in the range of 0.1-4.7 drawn on the total fat phase.

9. The edible oil-in-water emulsion according to claim 6, wherein the fat fraction comprises a mixture of palm oil and palm kernel oil.

10. The edible oil-in-water emulsion according to claim 9, wherein the palm oil is multiple fractionated palm oil stearin.

11. The edible oil-in-water emulsion according to claim 9, wherein the palm kernel oil is palm kernel oil stearin.

12. A process for preparing a water-in-oil emulsion comprising the steps of:
a) providing a fat phase as defined in claim 1;
b) providing an aqueous phase comprising the plant-based protein as defined in claim 1; and
c) adding the fat phase to the aqueous phase to obtain the water-in-oil emulsion.

13. A whippable cream and/or a multipurpose cream comprising the edible oil-in-water emulsion of claim 1.

14. (canceled)
